(19) United States
(12) Patent Application Publication
(10) Pub. No.: US 2015/0019440 A1
(43) Pub. Date: Jan. 15, 2015

(54) Encrypted Correction Code to protect the integrity and originality of electronic documentation and secure online payment and online wallet

(71) Applicant: Gongming Yang, ShangHai (CN)

(72) Inventor: Gongming Yang, ShangHai (CN)

(21) Appl. No.: 13/940,397

(22) Filed: Jul. 12, 2013

(51) Int. Cl. G06Q 20/38; G06Q 20/36

(52) U.S. Cl. CPC G06Q 20/3829; G06Q 20/36
USPC 705/65

(57) ABSTRACT

A method is provided for protecting the integrity and originality of electronic documentation and supporting securer and easier online payment using the Encrypted Correction Code which is correction code of the whole documentation and encrypted by the private key of RSA. The code is imbedded into 2D-barcode as RGB color value of pixels. First, 2D-barcode is generated with public-key ID, and then blend and imbedded into electronic documentation. Then the Correction Code is calculated and is encrypted by RSA private key. After that, the Encrypted Correction is mapped into color in the image of 2D-barcode. When the file is received, the integrity and originality is checked by comparing Correction Code decrypted from 2D-barcode with the Correction Code of the documentation. The present invention can be applicable to support more secure and easier online wallet using three-layer encryption and free from any personal information.

### TECHNICAL FIELD

The present invention relates to guarantee the originality and integrity of electronic documentation, public-key center, colorized encryption correction code, 2D-barcode, online wallet, online billing without personal information, three-level encryption, and in particular, it relates to exploit encrypted correction code which is encrypted by private key of RSA and the color of 2D-barcode to carry encrypted correction code.

### BACKGROUND ART

To guarantee the originality and integrity of important documentations such as check of bank, ticket, contracts, tax report etc, those documentations are all printed on paper, though, the costs for delivering, recording and retrieving documentation in paper is higher than electronic documentation. There is a requirement to use electronic file to keep important documentation. Yet, the electronic documentation can be easily copied, modified, added and ill-tampered. Also, as long as the photograph, the news, videos and the original articles are posted on internet, it is difficult for the owner or the creator to protect the copyright of their arts, and their interests. In addition, the internet users are exposed to tampered unauthorized information and misguided. So it is a general requirement to prevent electronic documentation from tampered and keep information of the creators of those arts, and make the creator of the arts respected and paid.

As the rapid growth of internet, it is required to protect personal information and the security of online billing information, and avoid phishing sites. To make online payment easy to use, many online billing only ask for account number, security number and the user's name, yet these personal information can be easily copied and be used without authorization. Without an effective method to detecting phishing sites, users are lured to log in those sites and submit bank information, those phishing sites then copy the bank information and make bad use of them. To protect online billing from unauthorized users, one of the possible solutions is to request users to input PIN number, another approach is to send a temporary password to user's mobile phone and ask the user type the temporary password to authenticate this access. The first solution might result in a bigger information leakage when the PIN number is leaked, because attacker can access the online bank using PIN number and do more damage. The second solution is very complicated, because the user need additional mobile phone, and can't finish payment without it. There also are many other techniques exist to make online billing more secure like SET, SSL, yet they are all too complicate to use. More than that, all those solutions rely heavily on the personal information of customer. As long as the personal information is transmitted, these information is possible to be leaked.

### SUMMARY OF INVENTION

### Technical Problem

The objects are listed as follows.

It is an object of the present invention to protect the integrity and originality of electronic documentation against unauthorized modification. This object can be divided into several small objects in details as follows. The first small object is to get the author's original information from electronic documentations, and give our respect to the author. For example, the electronic arts like news, pictures, photographs, videos etc can be easily copied and forwarded, we need a technique to know the exactly the owner of the arts. The second small object is to refuse electronic mendacious report from misguide us. For example, some of the unreliable organization release news on the name of other reliable organization, and those kind of information is misguiding and harmful, we need to know the true source which the news comes from. The third small object is to support sign contract remotely in a safe way. Some documentation such as contracts, tax reports, checks, invoices etc are important. Yet, it isn't convenient if all those need to be signed face to face in paper to protect the originality and integrity of the documentation. It is a normal requirement to keep those documentation originality and integrity.

It is an other object of the present invention to make online payment and online wallet service be free from submit personal information, be securer, be less message steps, be a quick and easy way to protect account after information is leaked.

### Solution to Problem

The solution of the objects is based on two important techniques: First is to use RGB color to implant the Encrypted Correction Code to make ECC become part of the electronic documentation. The second is to use RSA private key to authenticate users but not to protect the message transmitted in the internet. We assume that only the private key holder can generated encrypted message that can be decrypted to the message knew by all using public key. If we decrypt the encrypted message to a different message, the sender of encrypted message is not authorized by the owner of the public key.

The object of protecting the integrity and originality of electronic documentation is realized by: using public-key center to keep public-key and public-key ID, generating 2D-barcode, marking opaque and non opaque area of the 2D-barcode, blending 2D-barcode with original documentation, calculating correction code and encrypting the correction code, mapping encrypted correction code into color and forming a new electronic documentation.

The author of the electronic documentation generates RSA public and private keys either by the owner or by the public-key center. The length of RSA keys can be 512 bits, 1024 bits, 2048 bits or longer according to the security rank of the owner's documentation. Then the owner keeps the private key and sends the public key to the public-key center. The public-key center assigns a public key ID to the owner. After that, the owner generates a 2D-barcode with the public key ID and other personal information and makes the image of 2D-barcode as a part of the electronic documentation. To make the image of 2D-barcode a dependent part of the electronic documentation, the image of 2D code blends with the covered part of the electronic documentation. And then, the owner calculates the correction code using MD5 or DES/AES methods for the electronic documentation. The correction code is generated for the documentation excluding the place which is covered by opaque area of 2D-barcode's image. The opaque area and non-opaque is defined in FIG. 2. After correction code is generated, the owner calculates the encrypted correction code, using RSA private key, then maps the encrypted correction code into the RGB color value and copy it into a selected area of 2D-barcode. Then the new generated electronic documentation can be used in internet as the authenticated documentation.

The receiver of documentation checks the integrity and originality of the documentations by several steps. First the receiver analyzes the electronic documentation and retrieve the 2D-barcode, if this step succeeds, then gets the public key ID or public key from the 2D-barcode and decrypt the correction code from 2D-barcode by the public key from public-key center. In the next step, the receiver calculates the correction code according to the method to generate correction code which is recorded in ‘AD_t’ of the authenticated area. Then the two correction codes are compared. If the two correction codes are the same, the electronic documentation is original and intact, and the owner of the electronic document is the owner of the public key ID, otherwise, it is considered as modified by unauthorized attacker, or the documentation isn't original from the owner of the public key ID.

The object of online payment and online wallet service is realized by: using three-layer encryption to authenticate customer and E-commercial company by online wallet, allowing customer to authenticate E-commercial company to avoid phishing sites, using only public key ID and message which encrypted by private key to authenticate the user without transmitting personal information and private key in internet, protecting online billing by allowing customer to invalid public-key after the private key is leaked.

At the beginning of the solution, the customer and the E-commercial company authenticate each others using the public-key ID. Then the customer browser the website and book orders. When billing, the customer confirm the order and billing by encrypted them with customer's private key ID, and the E-commercial company encrypted its public-key ID together with customer's encrypted message by E-commercial company's private key, and then encrypted the whole message using the public key of online wallet center to make the message can be read only by online wallet service provider.

### Advantageous Effects of Invention

The correction code is calculated according to the electronic documentation and the image of 2D-barcode, and is sensitive to any modification of the electronic documentation or the 2D-barcode. If there are any tampers to the original documentation or the public key, the encrypted correction code can be affected and is almost impossible to be regenerated by attacker, so the tamper can be detected to prevent fraud. It is the same procedure to protect the copyright for original news or photograph when the documentation has encrypted correction code in it.

### BRIEF DESCRIPTION OF DRAWINGS

FIG. 1 illustrates the procedure to generate encrypted electronic documentation using 2D-barcode.

FIG. 2 illustrates the opaque, non-opaque and authenticated areas in the encrypted 2D-barcode.

FIG. 3 illustrates the definition of Pos_X, Pos_Y and Pos_wd in the 2D-barcode.

FIG. 4 illustrates the format of the data in the authenticated area of 2D-barcode.

FIG. 5 illustrates the detail definition of every item in encrypted message.

FIG. 6 illustrates the method to map encrypted correction code into pixels of image.

FIG. 7 illustrates the procedure to check the integrity and originality of documentation with authenticated 2D-barcode.

FIG. 8 illustrates how to apply this invention to support electronic check and how this invention against attacker.

FIG. 9 illustrates how the present invention to support online security wallet.

FIG. 10 illustrate the format of three-layer encrypted message.

### DESCRIPTION OF EMBODIMENTS

### Examples

There are three embodiments. Example 1 embodies the way to generate and check the integrity and originality of electronic documentation. Example 2 shows the embodiment of applying electronic check. Example 3 shows the embodiment of supporting online wallet.

### Example 1

This embodiment will be described based on accompanying drawings. In this example, the details of how to protect the integrity and originality of electronic documentation is described.

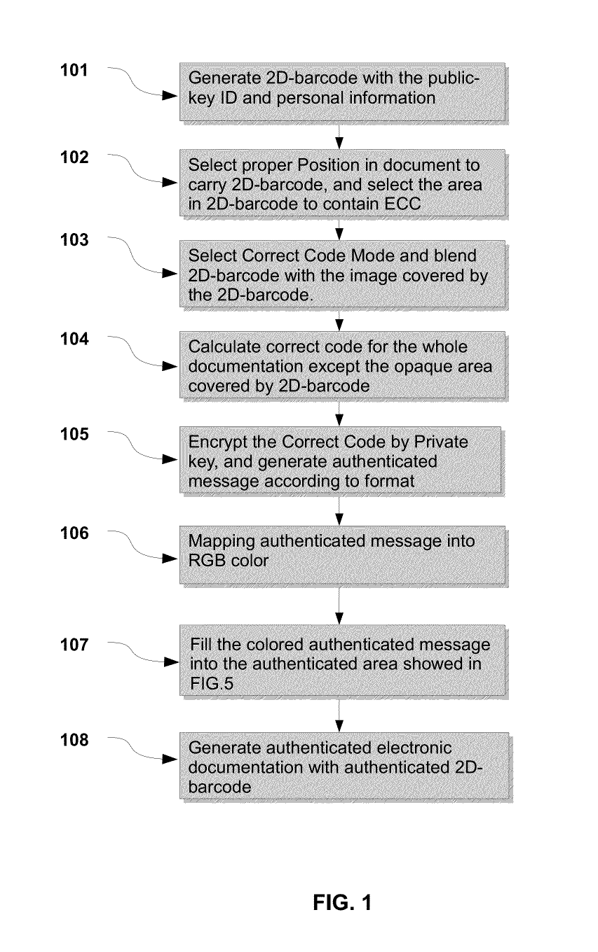

FIG. 1 illustrates the procedure to generate encrypted electronic documentation using 2D-barcode.

According to an embodiment of the invention, in the step 101, 2D-barcode is generated according to the owner's public-key ID and personal information.

In step 102, the method chooses a proper position on the documentation to paste 2D-barcode. After 2D-barcode is generated and placed in a selected position of the original documentation. The 2D-barcode is placed in the original documentation, and it is recommended that the area of 2D-barcode covers some characters or images in electronic documentation to prevent attacker from separating the 2D-barcode from electronic documentation and forging a new encrypted correction code. In practice, it will be more difficult to separate 2D-barcode from the documentation, if 2D-barcode covers the signature picture of the author.

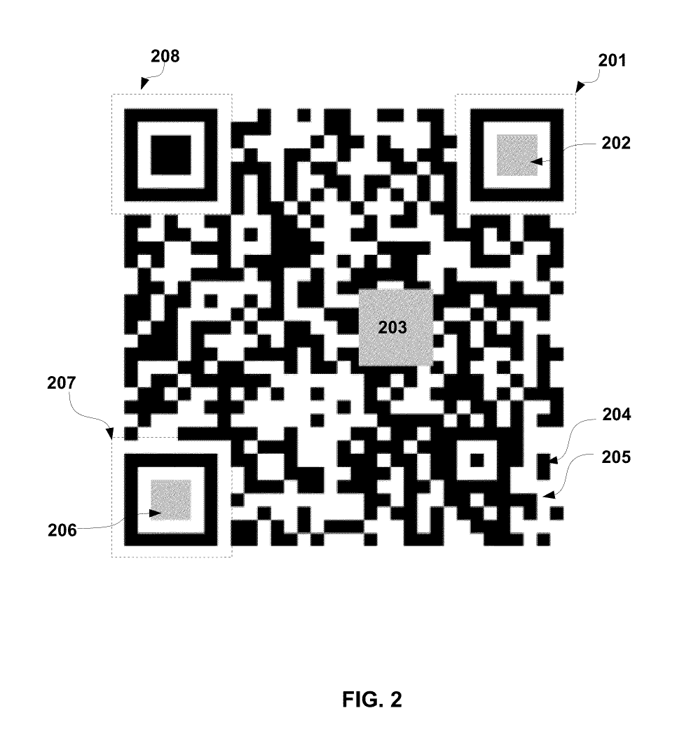

In step 103, the method to generate correction code is chosen according to the type of original documentation. If the documentation's type is image or any kind of format of picture, it is recommended to use MD5 method. If the documentation include characters with format, image, diagram etc, it is recommend to use AES or DES method to encrypt the whole documentation by the encrypt key recorded in 2D-barcode. In present invention, the 2D-barcode is divided into opaque area and non-opaque area. The opaque area contains 3 kinds of area includes: the authenticated area which is selected to carry encrypted correction code, the areas which are 2D-barcode bit with value 1 and are covered by black, the position area for locate 2D-barcode which is showed in position 208,2011,207 in FIG. 2. The areas other than the opaque areas are defined as non-opaque areas. In present invention, the opaque areas cover all information in the area of the electronic documentation, yet the non-opaque areas blend the white color with information in the area of the electronic documentation. The area of the electronic documentation beneath the 2D-barcode is printed into image called beneath original image. The non-opaque area of 2D-barcode blend with the beneath original image and form new color and use this new color to replace the original white color in the 2D-barcode. In the present invention, one of the requirements of the blend feature is that the information in 2D-barcode can still be retrieved, so, the color after blending still have to be easily separated from color of black. In order to achieve this, the blend coefficient of alpha chooses 0.23. Suppose that R/G/B represent the red and green and blue color of the documentation under the white area of 2D-barcode, the new R(red) color after blend is equal to 255*(1−alpha)+alpha*(R), similarly, the new G(green) color after blend is equal to 255*(1−alpha)+alpha*(G), the new B(blue) color after blend is equal to 255(1−alpha)+alpha*(B). The value of coefficient alpha is ready to be changed according to different type of electronic documentation.

In the step 104, Correction Code is calculated for the whole documentation except the file's head. If the documentation is image, the input is the pixels' color value of the image. If the documentation isn't image, the input is the bytes stream of the text, attached files with format and some images' pixels' color value include the image with the implanted 2D-barcode. In MD5 mode, the input is the whole electronic documentation, the calculation method is standard MD5 procedure, the output is the MD5 result and is defined as Correction Code. In this mode, any small changing of the electronic documentation will affect the value of Correction Code. In AES or DES mode, the input also is the whole electronic file, the calculation is standard AES or DES encryption, and the key is random generated and recorded into the authenticated area of the 2D-barcode which is one of the opaque area in the 2D-barcode, the output is the result of the AES or DES encryption result and is defined as Correction Code. The AES and DES mode supply additional security for the Correction Code, and this method is better for non-image documentation such as the email and text etc.

In the step 105, the owner of the documentation uses the owner's RSA private key to encrypt the correction code of the documentation and get the ECC. This procedure is a standard RSA encryption. The goal of encrypted correction code is to guarantee that there are no one except the author can generated an encrypted correction code which can be decrypted by public key and get the right Correction Code for the whole documentation.

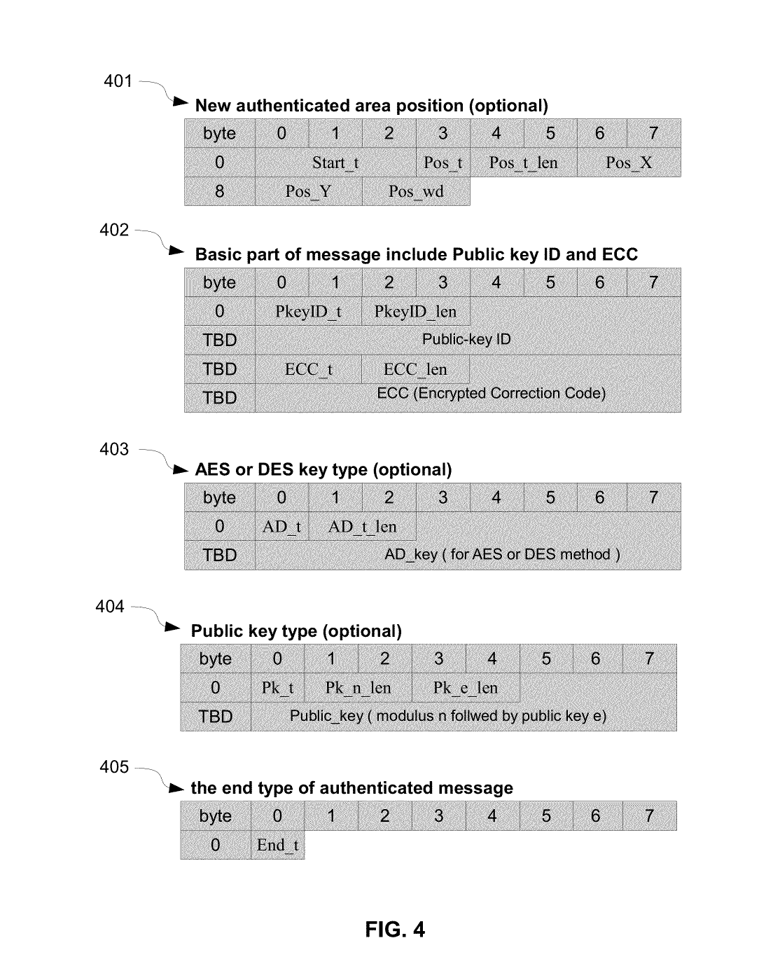

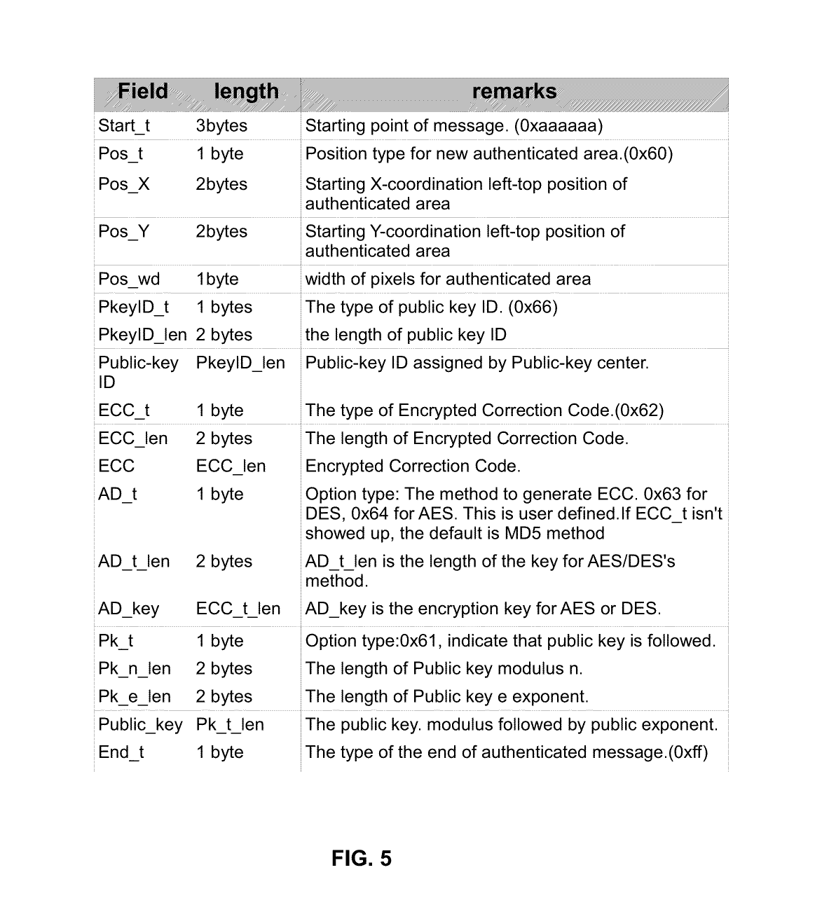

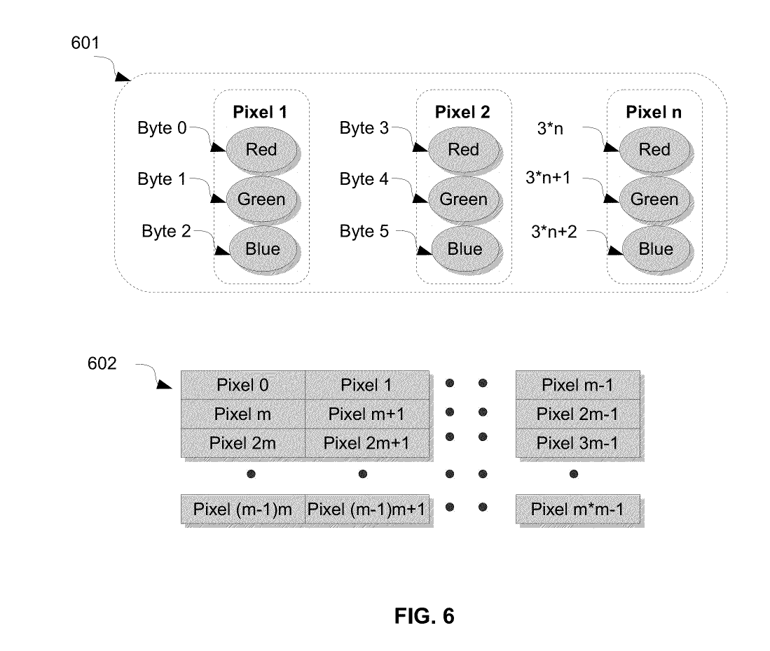

In the step 106, construct the authenticated message according to the format showed in FIG. 4 and FIG. 5, and then maps the authenticated message into RGB format according to the method showed in FIG. 6. The authenticated message have to contain Encrypted Correction Code and the Public-key ID, other kind of fields are optional.

In the step 107, fills the authenticated area in 2D-barcode with the authenticated message. After the step 106, the authenticated message are mapped into pixels which includes 3 bytes for RGB values, so this message is filled into the authenticated area pixel by pixel.

In step 108, the encrypted 2D-barcode is implanted into the original documentation and generate the new electronic documentation which is ready to be delivered. The output electronic documentation can be any kind of format such as image or PDF. If the documentation is image, then, the image have to be lossless to make the authenticated message in 2D-barcode retrievable. If the documentation isn't image, the 2D-barcode have to be an imbedded image which is lossless.

FIG. 2 illustrates the definition of opaque areas and blend areas in the encrypted 2D-barcode. 201,207 and 208 which are enclosed by dot square are 3 of the 4 positions areas of 2D-barcode. Those areas are opaque and cover corresponding area of the original documentation, and we can select 202 or 206 to carry authenticated message because those areas don't contain any data of 2D-barcode. We recommend to use the areas of 202 as long as there are more than 64 pixels in the square. Based on the different size of the 2D-barcode, it is possible that the area of 202 are not capable of hold the authenticated message. In this case, the designer can select a bigger area inner the 2D-barcode other than the position area to function as authenticated area. 203 is an example of this area. The size of the square area is restricted by the capability of error-correction of different type of 2D-barcode. The owner of the documentation can use this feature to get area big enough to hold longer ECC data. 205 is the area with ‘1’ value in 2D-barcode which is defined as opaque area, and 206 is the area with ‘0’ which is defined as non-opaque area. All non-opaque area will blend with original documentation to prevent attacker to replace the 2D-barcode in the documentation.

The area 202 is a special area that have to have some authenticated message. After the 2D-barcode is located, the Area of 202 is been searched for the basic information of the authenticated message. If authenticated message is put into 202, then, the first field of the message will be 402 which is described in FIG. 4, else the first field of the message will indicate the position and the size of authenticated area which showed in 401 of FIG. 4 which indicates the ‘Post’ options to tell where the rest of authenticated area lies in. The field of ‘Start_t’ occupies the first 3 bytes, is used to indicate the starting of message.

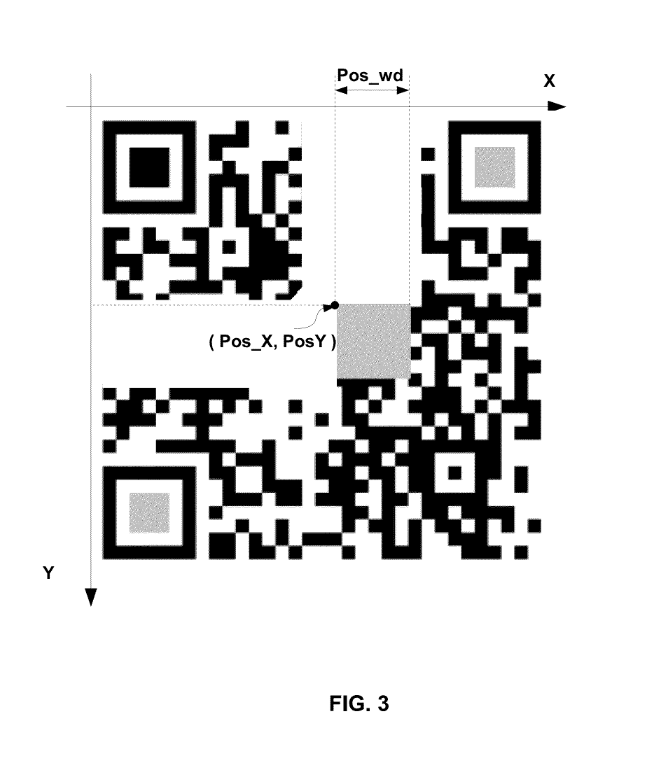

FIG. 3 illustrates the definition of Pos_X, Pos_Y and Pos_wd in the 2D-barcode. The gray square area in the 2D-barcode is the authenticated area. If the authenticated area is selected other than the area 202, the ‘Pos_X’, ‘Pos_X’ and ‘Pos_wd’ will be defined in option ‘Pos_t’, otherwise, this area shouldn't exist.

FIG. 4 illustrates the format of the authenticated message of 2D-barcode. The authenticated message is a combination of fields which is encoded as TLV (type-length-value) elements. The type ‘Start_t’ and ‘End_t’ are two special type that have not value followed. The type ‘Start_t’ indicates the start of a message used as a locate signal. The type ‘End_t’ indicates the end of message. 401 shows the message when a new authenticated area is defined. The type ‘Pos_t’ indicates the position information of authenticated area. This type is optional and only exist when a new authenticated area is defined. The definition of ‘Pos_X’, ‘Pos_Y’ and ‘Pos_wd’ is showed in FIG. 3. 402 shows the message head of the authenticated message, this field is required. This field contains two types, one is ‘PkeyID_t’ type to set Public-key ID and another one is ‘ECC_t’ to set Encrypted Correction Code. 403 shows the type of ‘AD_key’, this type is to set the encryption key for AES or DES. It is optional and will exist only when we use AES or DES mode to calculate the Correction Code which the key for AES or DES is required for input. In default, the MD5 method is used and there isn't ‘AD_t’ in the authenticated message. 404 shows the public key type, this message is optional. If this public key is different from the public key got from public-key center by public-key ID, the documentation can be regarded as tampered. 405 shows the end type of authenticated message, this type indicate the end of authenticated message.

FIG. 5 illustrates the detail definition of every item in encrypted message.

FIG. 6 illustrates the way to map encrypted correction code into pixels of image. Every pixel includes 3 color components, R for red, G for green, B for blue. This figure shows how to map 3*n bytes of data into n pixels. The data are arranged in Big-end mode which the left most byte is the most important byte. 601 shows how the bytes are arranged. The first Pixel contains 3 byes, the first is the value of R, then the G, and then the Blue. The bytes stream is Byte0,Byte1,Byte2 . . . Byte(3*n+2). 602 shows how the bytes are arranged in the authenticated area. Suppose the authenticated area is an m*m pixels square area, the pixels sequence is from the top left to top right and then move to the next pixels row. The value of authenticated area can be retrieved in this scanning sequence.

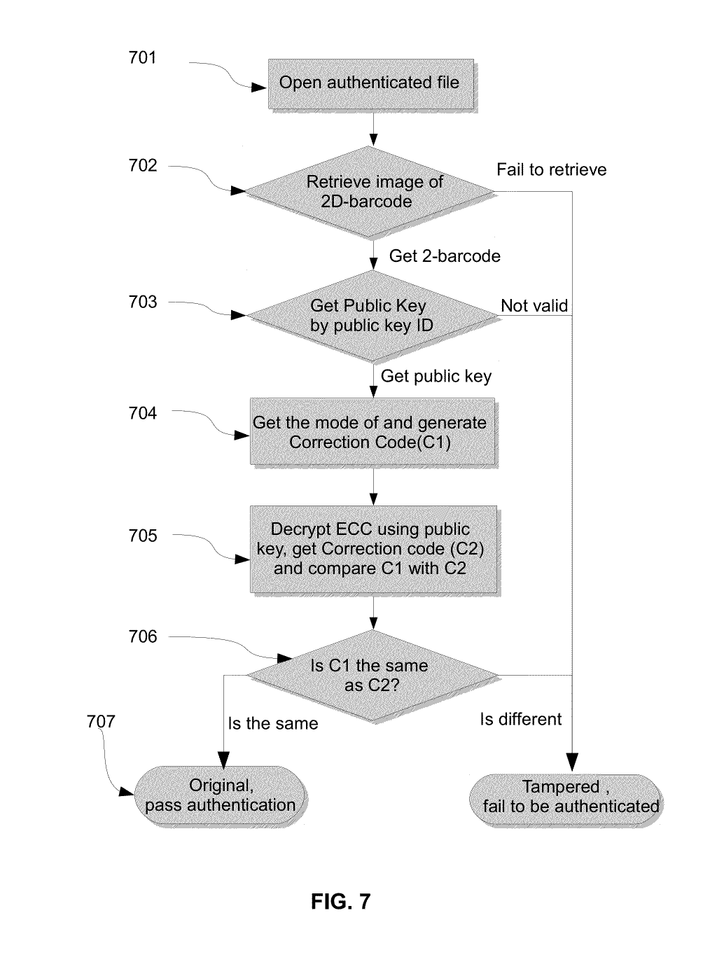

FIG. 7 illustrates the procedure to check the integrity and originality of documentation with encrypted 2D-barcode. In step 701, the target electronic file is open and the head of the file is eliminated. In step 702, the receiver retrieves 2D-barcode from the images. If there isn't any image in the electronic documentation, the documentation is regarded as tempered or unauthorized. This step will try to search all the images in the electronic documentation to find the 2D-barcode. If it fails to locate the image of 2D-barcode, then the electronic documentation is regarded as unauthorized or tempered documentation. In the step of 703, we retrieve all the information from 2D-barcode including the public-key ID. Based on the public-key ID, we gets public-key from public-key center. If public-key ID doesn't exist in 2D-barcode or the public-key ID doesn't exist in the public-key center, the documentation is regarded as unauthorized or tempered documentation. Other information retrieved from 2D-barcode isn't defined but can be looked as an additional checking information which can be compared with the additional information of this public-key ID which is returned from public-key center. In step 704, the calculation of correction code is retrieved from 2D-barcode, if ‘AD_t’ doesn't exist, the method is regarded as MD5 method by default. Then we calculate the correction code of current electronic documentation based on step 104 in FIG. 1, Suppose the correction code is C1. In the step of 705,we retrieve the encrypted correction code from RGB value of the pixels in the encrypted area of 2D-barcode, and then uses the public key get from public-key center to decrypt ECC. Suppose the result of the correction code is C2. In this step, we can do more strict check by getting the public-key from the 2D-barcode, and compare the public-key with the public-key gotten from public-key center, if they aren't the same, we can regard this documentation as tampered. In the step of 706, the two correction code C1 and C2 is compared. If the two are the same, then this electronic documentation is regards as original from the owner without tamper, otherwise, this documentation is regards as tampered.

### Example 2

In this example, the details of how to support electronic cheque or check of bank is described.

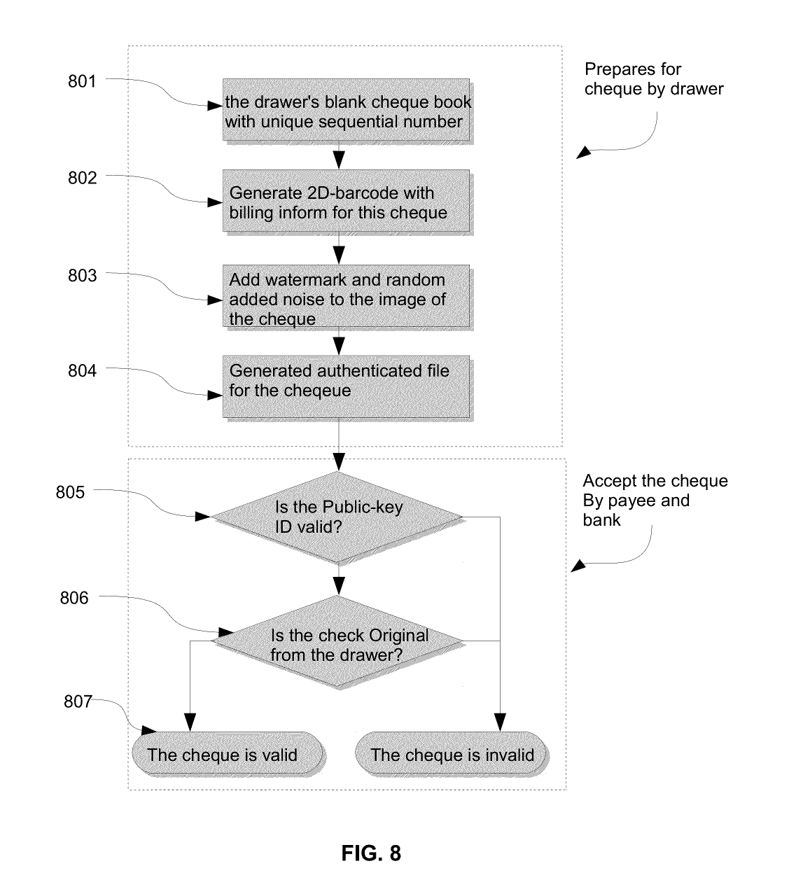

FIG. 8 illustrates how to apply the present invention to support electronic check and how this invention against attacking the electronic check. Normally, people write and sign on the check and then deliver it by hand or by mail. Bank will take the sign of the drawer by hand as a kind of authorization from the drawer, so bank can transfer the money of the check from the drawer to the payee. Yet, sending mail to the acceptor take times and consume paper resources, also it takes manpower and times to check the signature on the check, as well as costs resource of mail system to deliver the check to the payee. The present invention makes the electronic check operable which is showed in FIG. 8. The steps from 801 to 804 are required for drawer. In 801, drawer get an electronic blank check from bank with sequential number assigned by the bank. The blank check is an image. In step 802, the drawer input the billing information and generates a 2D-barcode, the billing information can include the name of payee, the amount of the money, the usage of the check, and other required information by the bank. In step 803, the drawer generates some random noise or watermark on the image of the check to make this image of check unique and difficult to be imitated. This step is optional according to the secure level required by bank. In step 804, the drawer generate an authenticated cheque with authenticated 2D-barcode according to the steps described in FIG. 1.

The steps from 805 to 807 are the validation process in the payee or bank side. When payee receives the electronic authenticated cheque and delivers it to bank, the bank need to check the validation of the cheque. In the step 805, the bank will first retrieves the information from 2D-barcode and get public-key ID of the drawer, then gets public key from public-key center. If this public key ID doesn't comes from the owner of the check, the bank can invalid this check. In step 806, the bank checks the validation of the check by the same steps showed in FIG. 7. If the cheque is original from drawer without tamper, the bank can transfer the money according to the billing information in the electronic authenticated cheque from drawer to payee, otherwise, the cheque is invalid.

In the process of the validation procedure, the validation of private key is the only information need to be protected, so it is more secure than methods exist so far. Suppose the attacker steals the image of the bank-check with encrypted 2D-barcode and try to tamper the documentation, the attacker need to regenerate the encrypted correction code if the attacker does any modification for the electronic documentation. Yet, the encrypted correction code can be accepted by the bank only when the attacker uses the RSA private key which is the same key-pair with the public key stored in the public-key center for the pubic-key ID. It is very hard even impossible for an attacker to find the RSA private key out.

### Example 3

In this example, the details of embodiment of online wallet services is described.

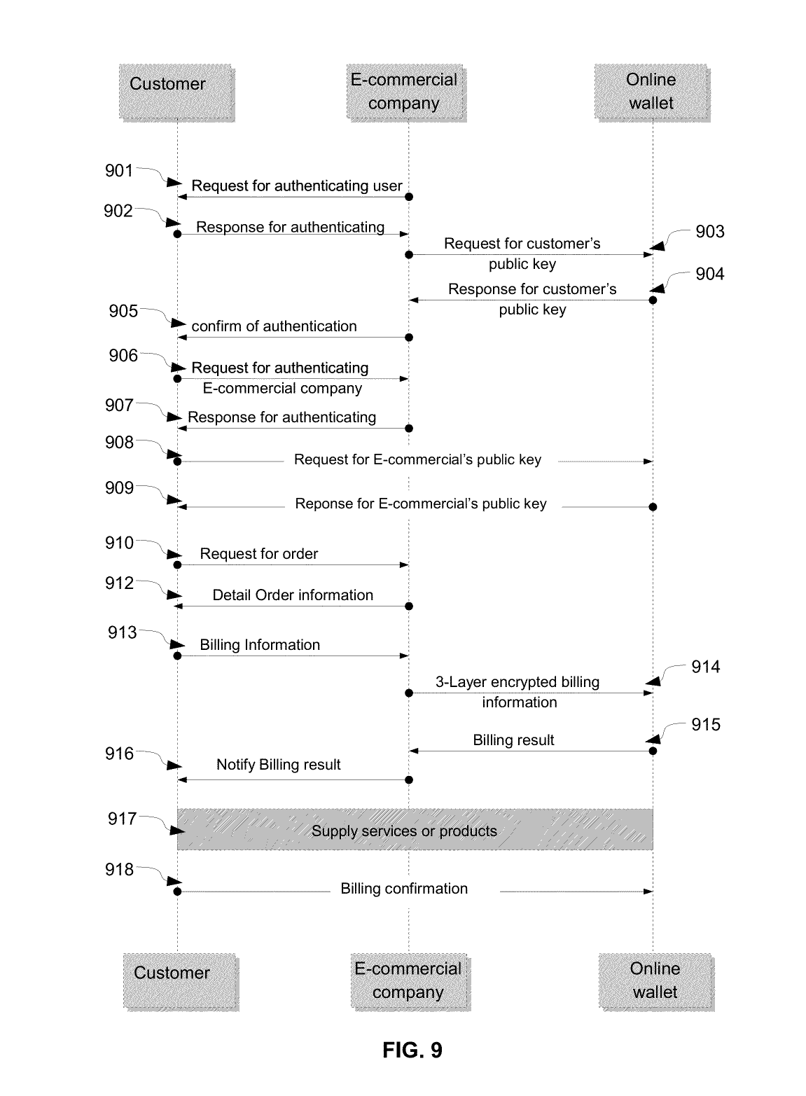

FIG. 9 illustrates how the present invention to support online secure wallet. There are 3 parts for this system, the customer is the user who orders something from E-commercial company, the E-commercial company is the merchant who provides products or services to customer online, the online wallet is the system to support online payment between customer and merchant, also is the public key center. Before online purchase, customer and merchant (e-commercial company) should have accounts and public key on online wallet system and should transfer money enough to their online wallet account.

In steps from 901 to 909, customers and merchant authenticate each others. First, merchant authenticates the customer by the public-key ID hold by the customer. In step 901, after the customer request login to the website, the merchant starts authentication by generating an 8-byte random number and send to customer. In step 902, customer attaches the random number behind the user's information which can includes user name and password, and encrypts this message by private key, and then attaches the public-key ID in front of the encrypted message to merchant. In step 903, merchant requests the public key and the rank of the customer from online wallet by the public key ID of the customer. The message from merchant to online wallet is encrypted by the public key of online wallet. In step 904, merchant get customer's public key and credit rank. If the credit rank of customer is too low or the customer can't pass the validation of online wallet, for example the customer isn't an account hold of online wallet, then E-commmercial company can refuse this customer. Then, merchant will decrypt the encrypted message from customer and get the random number, if the random number should be the same as the random number sent by merchant, otherwise the customer can't pass authentication. In step 905, merchant allows the customer to login or informs the result of authentication. In step 906, the customer requests authentication of the merchant with 8-byte random number attached on the message. In step 907, merchant encrypted the 8-byte random number and attaches it's public-key ID to the customer. In step 908, customer gets merchant's public-key, the merchant's rank and the title of this merchant from online wallet. If the rank is lower than expected, the customer can leave the website of this merchant for security. If the rank is higher enough and the title of the merchant is the same as the website visited, the customer decrypts the random number with merchant's public key. If the decrypted random number is the same as the random number sent out by the customer, the merchant passes the authentication from the customer, otherwise the website of the merchant may be phishing site, and the customer can leave the website for sake.

After the merchant passes the authentication, the customer browses the website of the merchant. In step 910, the customer decides to pay for goods or services, and book an order. In step 912, the merchant checks the order and generates details information of the order, such as the number of products, the available number of products, the transaction ID, the billing information etc. Then the merchant encrypted details information by the merchant's private key and sends to customer. In step 913, the customer decrypts the details information of the order by the public key of merchant, and check the billing information. If the customer accepts the details order information, then, the customer encrypts the billing information which is essential for billing using the customer's private key. And generates a message with the encrypted billing information, and then encrypts the message using the public key of merchant, and sends to merchant. In step 914, the merchant will finish billing by the message of three-level encryption. The first level of encryption is finished by customer, and the merchant need check this billing information by decrypting the message using the public key of the customer, checks the order information with the merchant's database. If all are correct, the merchant generates a billing request message with the encrypted billing information from customer, the public key ID of the merchant and that of the customer. And then the merchant encrypts this message using the private key of the merchant, and encrypts the encrypted message again using the public key of the online wallet. After that, the merchant finish the request message with three-layer encryption and sent to online wallet for billing.

In step 915, online wallet decrypt the request message using the private key of online wallet. Then get the public key ID of the merchant and the customer. Then checks the rank of the merchant and customer and decrypts the billing message by the public key of merchant first, then decrypts using the public key of the customer. In this step, merchant can't fabricate the billing information from customer and the customer can't fabricate the message from merchant. If any forgery occurs, the online wallet can't get meaningful information from the billing message, so, the online wallet can finish billing based on this message in one step. If the money left in customer's account in the online wallet is enough, the online wallet transfer money asked in billing message into the merchant's account. To make online trade more secure, the new money is frozen for a set period of time. The frozen time and the billing result are sent to the merchant as billing confirmation.

In step 916, the merchant sends the billing result to customer, then the billing is finished. In step 917, the merchant start to do offline trading, such as, prepare for goods or services and deliver the goods and services. After receives the goods or services, the customer can confirm the billing on the system of online wallet. If the customer does so, the money of this transaction is unfrozen right away. If the customer doesn't confirm after frozen time, the money of this transaction is unfrozen too. In some case, the customer isn't satisfied with the goods and services, the customer can complain the merchant, and the transaction can be finished or canceled or delayed according to the result of complaint.

When the RSA private key is leaked to attacker, the owner can invalid the public key ID and update a new public key to the public-key center as soon as the owner or bank found the RSA key is leaked. When the public key is updated after the leakage, the bank can't get valid public key by the old public key ID from public key center, so the attack with the old private key will be prevented after the bank find the online billing information is tampered. Moreover, from the aspect of the spirit of the contract, the bank can be exempt because it is the responsibility of the customer to keep the private key secure. The customer will keep an eye on the safety of the private key, and prevent from being attacked as soon as possible.

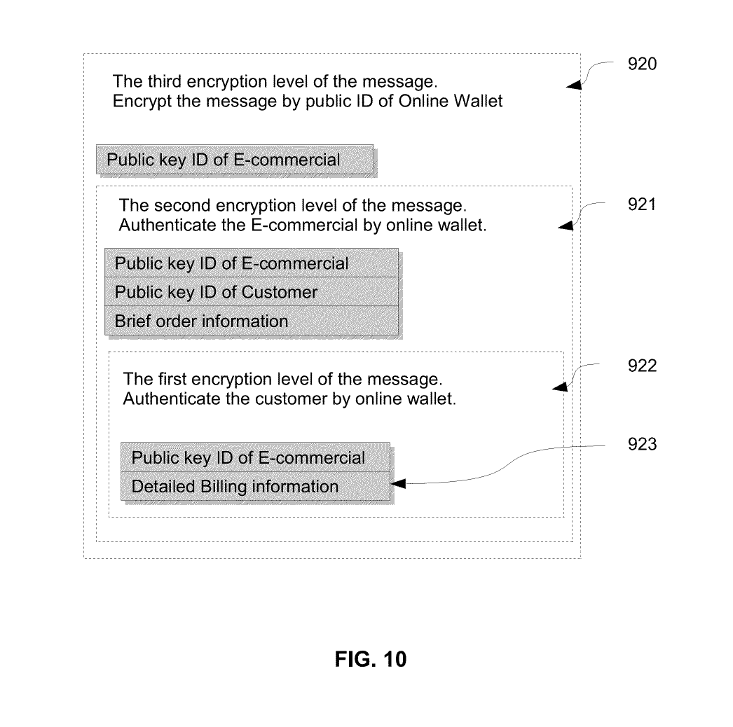

FIG. 10 illustrates the format of billing message sent from merchant to online wallet. It is a three-layer of encryption.

Block of 923 is the billing information from the customer which contain all the billing information needed by online wallet. Online wallet system know both the customer's account and the merchant's account by their public key ID, and the sum of money is recorded in the detailed billing information. This critical message will be encrypted first by the private key of the customer and form the encrypted message packet of 922. The message of 922 with the public key ID of E-commercial, the public key ID of customer and the brief order information form the main message of the second layer of billing message. All those data are encrypted by the private key of the merchant and form encrypted message of 921. The message of 921 contains all the authentication information for the customer and the merchants. To make the message of 921 transmitted across internet, it is encrypted by the public key of online wallet to prevent the message is peeked by unauthorized person even the message is encrypted. When online wallet receives the three level encrypted billing message, it can decrypt this message and get correct billing information and finish the billing procedure. If the message is received by attacker, the attacker has to know the private key of the customer and the private key of the merchant, otherwise, the attacker can't forge a valid three-level encrypted billing message.

1. A method for authenticating the originality and integrity of electronic documentations, the method comprising: Identifying online user by RSA algorithm, constructing encrypted correction code for documentations, and encrypting correction code by Asymmetric encryption RSA, and constructing an authenticated image to record Encrypted Correction Code (ECC) and public key ID and public key using the color of pixel, and implanting the image of authenticated image into authenticated area of 2D-barcode, blending the non-opaque area of 2D-barcode with the electronic documentation, and checking the integrity of electronic files by the authenticating 2D-barcode.

2. The method of claim 1, wherein constructing an authenticated image, the method comprising: selecting authenticated area in 2D-barcode to carry the authenticated image, mapping ECC and public key ID and other information into RGB color value, and constructing authenticated image by the RGB value of the pixels on the image, according to the designed format.

3. The method of claim 1, wherein constructing Encrypted Correction Code for all kinds of files include but not limited to image files or scanned documentation, text or text with format, PDF format, drawings like CAD format etc., the method comprising: defining opaque area and blend area of 2D-barcode, blending the blend area of 2D-barcode with the electronic documentation, defining the part of area in the electronic documentation for generating correction code, generating correction code based on hash function MD5 method, or generating correction code based on encryption method of DES or AES.

4. The method of claim 1, wherein Identifying online user by RSA algorithm, the method comprising: building public key center which allocates RSA key and RSA public key ID for users, accessing the public key ID online and get public key online from public key center, ranking users according to the length of RSA key, providing the information of user's rank level for authorized organization such as bank, keeping the information of users, keeping important authenticated image of some electronic documentation.

5. The method of claim 1, wherein encrypting correction code by Asymmetric encryption of RSA, the method comprising: encrypting correction code using user's private key which is only kept by original author of documentation.

6. The method of claim 1, wherein implanting the image of ECC and public key into 2D-barcode, the method comprising: implanting the authenticated image which contains encrypted ECC and RSA public key and RSA public key ID into authenticated area of the 2D-barcode.

7. The method of claim 1, wherein checking the integrity of electronic images and files by 2D-barcode, the method comprising: detecting and retrieving user's information from authenticated image inbound in the 2D-barcode, calculating the ECC of the documentation or image according to the type of ECC, getting public key from web, decrypting ECC, and comparing the decoded ECC with the calculated ECC.

8. The method of claim 4, wherein ranking users according to the length of RSA key, the method comprising: giving higher rank for the public key ID with longer length of RSA key, applying different security for different rank, the higher rank with more strict user information checking.

9. The method of claim 4, wherein building public key center, the method comprising: Allocating RSA public and private key for users, Assign global unique public-key ID for users, retrieving public key by global unique public-key ID, maintaining public-key ID list for users, invaliding public-key ID to prevent from attacking.

10. The method of claim 4, wherein keeping important authenticated image of some electronic documentation, the method comprising: recording the time of generating ECC of the important documentation, recording 2D-barcode and the authenticated image for this documentation.

11. A method of providing more secure and easier online wallet services without using any personal information, the method comprising: e-commercial company authenticates customer by public key ID, customer authenticates e-commercial company by public key ID, online wallet authenticates both customer and e-commercial company by three-layer encryption of billing message, billing message is free of any personal information, online wallet finishing transaction between e-commercial company and customer by the billing message which is wrapped in three-layer encrypted message in one step, supporting frozen time for customer to verify the goods of services supplied by the e-commercial company.

12. The method of claim 11, wherein online wallet finishing transaction between e-commercial company and customer by the billing message which is wrapped in three-layer encrypted message in one step, the method comprising: the first level encrypting billing information by private key of customer, the second level encrypting message of first level by private key of E-commercial company, the third level encrypting message of second level by public key of online wallet, only one message contain all authentication information.

13. The method of claim 11, wherein customer authenticates e-commercial company by public key ID, the method comprising: authenticating the website by public key ID to avoid phishing site.

14. A method for supporting security electronic check with encrypted correction code (ECC), the method comprising: applying ECC on the electronic check, comparing the information recorded in public key center for the user with the information record in the authenticated area of the electronic check.
